(19) United States
(12) Patent Application Publication
(10) Pub. No.: US 2006/0020977 A1
(43) Pub. Date: Jan. 26, 2006

(54) Television broadcast signal receiving system

(75) Inventor: Toshihiro Takagi, Osaka (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Osaka (JP)

(21) Appl. No.: 11/175,301

(22) Filed: Jul. 7, 2005

(30) Foreign Application Priority Data
Jul. 8, 2004 (JP) 2004-201708

(51) Int. Cl. H04N 7/20

(52) U.S. Cl. 725/72

(57) ABSTRACT

In a TV broadcast signal receiving system capable for connecting a plurality of TV broadcast signal receivers to a single multi-directional antenna without using modular cables, each TV broadcast signal receiver outputs a control signal with apparatus identifying information including an antenna control signal, apparatus ID and priority level thereof for controlling an effective signal receiving direction of the multi-directional antenna and a gain of an amplifier. The multi-directional antenna compares the priority level included in the control signal newly received with that of the control signal previously received. When the priority level of the control signal newly received is equal to or larger than that of the control signal previously received, the antenna control signal is extracted from the control signal, and the effective signal receiving direction of the multi-directional antenna is switched corresponding to an indication of the antenna control signal.

### BACKGROUND OF THE INVENTION

1. Field of the Invention

The present invention relates to a television broadcast signal receiving system for receiving television broadcast signals delivered from a plurality of directions.

2. Description of the Related Art

In the North American Continent where an ATSC digital television broadcast (it is abbreviated to a hereinafter digital TV broadcast) is performed, plains are dotted with metropolises, so that various digital TV broadcast signals broadcasted in the suburbs of each metropolis can be received at other cities or the halfway point of the cities. In consideration from a user who receives the TV broadcast signals, since many TV broadcast signals are transmitted in various directions, it is necessary to regulate a direction of an antenna in an orientation to a TV broadcasting station from which a program which he wants to watch is delivered. Therefore, a multi-directional antenna such as a smart antenna is put into practical use. According to the EIA-909 technical standard, it is provided that a smart antenna has sixteen signal receiving directions in respective directions where a circle is divided into sixteen.

A television broadcast signal receiver connected to such a multi-directional antenna is capable of adjusting an effective signal receiving direction of the multi-directional antenna. In the EIA-909 technical standard, it is prescribed that the television broadcast signal receiver is connected to the multi-directional antenna via a modular cable so as to transmit a control signal from the television broadcast signal receiver to the multi-directional antenna. Therefore, transmitting and receiving of the control signal are performed through a CEA-909 interface between the television broadcast signal receiver and the multi-directional antenna connected by the modular cable.

By the way, among conventional television broadcast signal receiving systems using a unidirectional antenna, there is no system that connects the television broadcast signal receiver to the unidirectional antenna by the modular cable. Thus, in the above-mentioned television broadcast signal receiving system that connects the television broadcast signal receiver to the multi-directional antenna by the modular cable, there is a fear that a user is confused when setup of the system.

In addition, in the conventional television broadcast signal receiving system using the unidirectional antenna, a plurality of television broadcast signal receivers can be connected to a single unidirectional antenna. In contrast, in the television broadcast signal receiving system using the multi-directional antenna, optimum signal receiving direction of each channel may be different. When a plurality of television broadcast signal receivers are connected to a single multi-directional antenna, it is necessary to adjust capability to control the effective signal receiving direction of the multi-directional antenna between the television broadcast signal receivers.

As for a method to control the communication among a plurality of terminal apparatuses, the documents of Japanese Laid-Open Patent Publications No. 7-307742, No. 11-55266 and No. 2001-237839 are known.

However, there is no television broadcast signal receiving system which can control the multi-directional antenna from the television broadcast signal receiver without using the modular cable. Furthermore, there is no television broadcast signal receiving system which can adjust the capability to control the multi-directional antenna among a plurality of television broadcast signal receivers, when the television broadcast signal receivers are connected to the same multi-directional antenna. Even when the techniques shown in the above-mentioned prior art documents are applied to the television broadcast signal receiving system using the multi-directional antenna, it is impossible to solve these problems.

### SUMMARY OF THE INVENTION

A purpose of the present invention is to provide a television broadcast signal receiving system, in which setting up of a multi-directional antenna and a television broadcast signal receiver can be made easier, and a single multi-directional antenna can be used commonly by a plurality of television broadcast signal receivers.

A television broadcast signal receiving system in accordance with an aspect of the present invention comprises a multi-directional antenna having a plurality of signal receiving directions previously defined and at least one television broadcast signal receiver connected to the multi-directional antenna for receiving a television broadcast signal.

The television broadcast signal receiver has a tuner connected to the multi-directional antenna and receiving a television broadcast signal, and a transmitter for transmitting an antenna control signal to the multi-directional antenna via a wireless transmission so as to switch an effective signal receiving direction of the multi-directional antenna while receiving the television broadcast signal.

The multi-directional antenna has a receiver for receiving the antenna control signal transmitted from the transmitter of the television broadcast signal receiver, and a switch for switching the effective signal receiving direction among a plurality of signal receiving directions of the multi-directional antenna corresponding to the antenna control signal.

By such a configuration, the antenna control signal is transmitted from the television broadcast signal receiver to the multi-directional antenna via the wireless transmission without using the modular cables, so that the setting up of the television broadcast signal receivers and the multi-directional antenna can be made simple and easy.

### BRIEF DESCRIPTION OF THE DRAWINGS

FIG. 1 is a conceptual diagram showing a circumstance for receiving digital television broadcast signals in home;

FIG. 2 is a block diagram showing a configuration of a television broadcast signal receiving system in accordance with an embodiment of the present invention;

FIG. 3 is a conceptual diagram showing signal receiving conditions of a multi-directional antenna used in the system;

FIG. 4 is a flowchart showing a process for automatically scanning an optimum signal receiving direction of each channel by a television broadcast signal receiver used in the system;

FIG. 5 is a flowchart showing a process for scanning all channels in all signal receiving direction of the multi-directional antenna by the television broadcast signal receiver used in the system;

FIG. 6 is a table showing relations between the channels and optimum signal receiving directions formed by the process shown in FIG. 5;

FIG. 7 is a flowchart showing a process for transmitting a control signal by a transmitter of the television broadcast signal receiver;

FIG. 8 is conceptual diagram showing processes for transmitting and receiving the control signal; and

FIG. 9 is a flowchart showing a process for receiving the control signal by a receiver of the multi-directional antenna.

### DETAILED DESCRIPTION OF THE EMBODIMENT

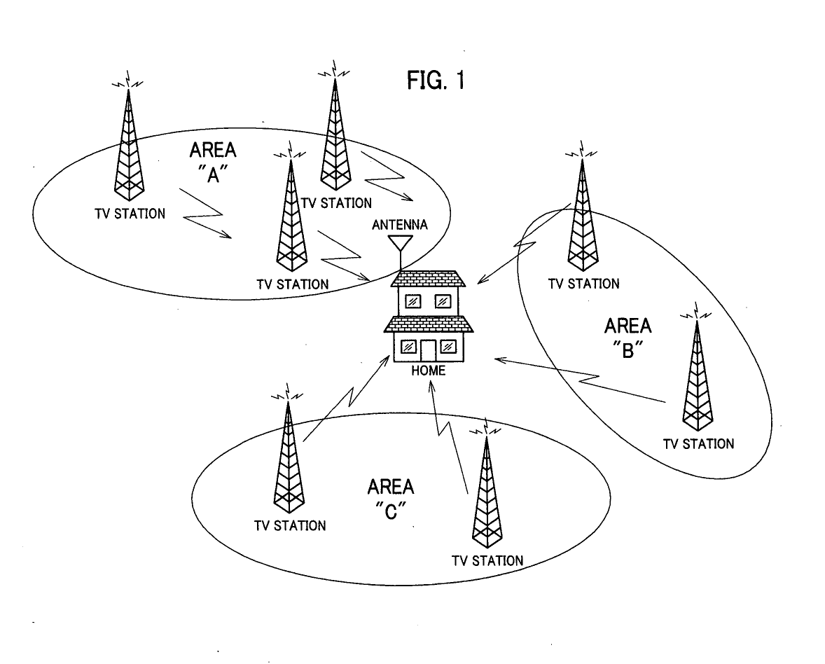

A television (TV) broadcast signal receiving system in accordance with an embodiment of the present invention is described with reference to figures. A circumstance for receiving TV broadcast signals in home is shown in FIG. 1. In an area where grand-based digital TV broadcast is performed, when an intensity of received signal of a digital TV broadcast signal is equal to or larger than a predetermined threshold value, an image having a predetermined image quality can be obtained by correction. Thus, it is possible to view TV programs by receiving TV broadcast signals which are delivered from TV stations existing at many positions in such as areas designated by symbols A, B, C, and so on, as shown in FIG. 1. According to such a circumstance, various types of multi-directional antennas called smart antenna having a plurality of signal receiving directions are put into practical use.

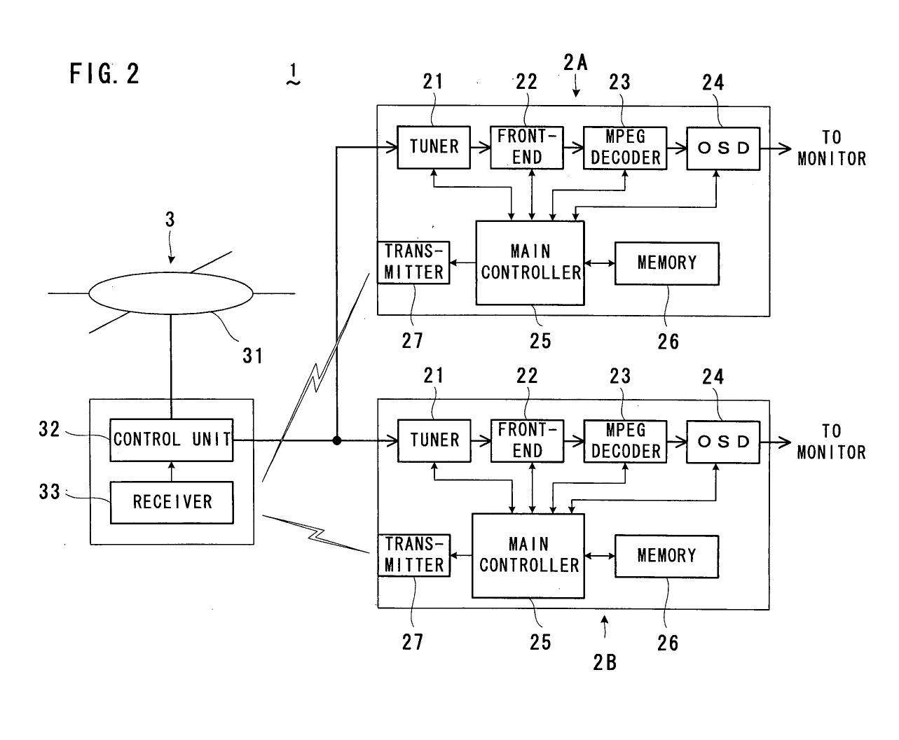

The TV broadcast signal receiving system is configured for including one or a plurality of TV broadcast signal receiver and one or a plurality of multi-directional antennas. FIG. 2 shows an example of that two TV broadcast signal receivers 2A and 2B are connected to a single multi-directional antenna 3. The TV broadcast signal receivers 2A and 2B respectively receive a TV broadcast signal among many TV broadcast signals delivered in a predetermined frequency band from TV stations disposed at various locations by switching an effective signal receiving direction of the multi-directional antenna 3, and outputs a TV program on a monitor display apparatus with using the TV broadcast signal. In this description, a physical channel which is a frequency bandwidth of carrier wave used for transmitting the TV broadcast signal is merely called as a channel.

Each of the TV broadcast signal receivers 2A and 2B is comprised of a tuner 21 connected to the multi-directional antenna 3 and receiving a TV broadcast signal, a front end 22 performing a predetermined signal processing to the TV broadcast signal received by the tuner 21 for decoding the TV broadcast signal, an MPEG decoder 23 decoding the TV broadcast signal compressed in compliance with the MPEG standard, an on screen display (OSD) unit 24 superimposing a data of predetermined display image on the decoded TV broadcast signal, a main controller 25 sensing a signal receiving condition of the TV broadcast signal, outputting an antenna control signal for controlling a control unit 32 of the multi-directional antenna 3, and controlling the entire of the TV broadcast signal receiver 2A or 2B, a memory 26 memorizing a table of signal receiving directions and so on, and a transmitter 27. The TV broadcast signal decoded by the MPEG decoder 23 is outputted to a monitor display apparatus through the OSD unit 24 so that an image is displayed on the monitor display apparatus with using the TV broadcast signal.

The table of signal receiving directions memorized in the memory 26 includes information of channel numbers delivered from the TV stations, optimum signal receiving direction (abbreviated as optimum direction in flowchart) of each channel when the TV broadcast signal of the channel is received by the multi-directional antenna 3, and registered channel information showing whether the channel is registered as receivable or not. Hereinafter, a condition that a specific channel is registered as receivable is described as an ADD flag is ON state, and a condition that a specific channel is not registered as receivable is described as the ADD flag is OFF state. In addition, when the registered channel information is deleted from the table of signal receiving directions, it is described as the ADD flag is changed from ON state to OFF state. When the registered channel information is added to the table of signal receiving directions, it is described as the ADD flag is changed from OFF state to ON state.

The transmitter 27 serves as a control signal generator and a control signal transmitter when it performs control signal processing based on the antenna control signal inputted from the main controller 25.

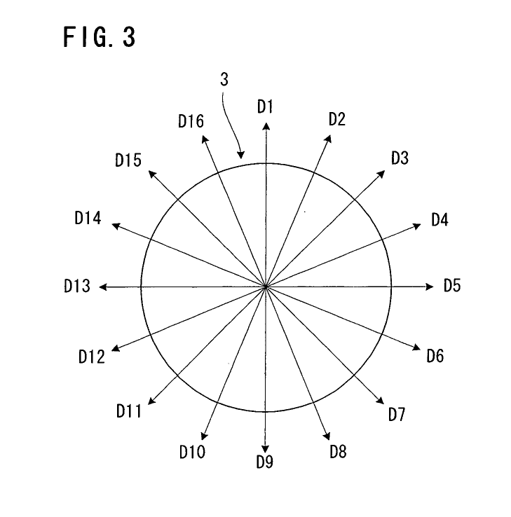

The multi-directional antenna 3 which is called smart antenna comprises an antenna unit 31 for receiving TV broadcast signal, a control unit 32 for controlling the motion of the antenna unit 31, a receiver 33, and an amplifier (not shown) for amplifying the TV broadcast signal received by the antenna unit 31. The antenna unit 31 has, for example, sixteen signal receiving directions D1 to D16 as shown in FIG. 3, and an effective signal receiving direction is selected among these sixteen signal receiving: directions by electrically switched on and off of electronic switches or mechanically moving an antenna (these elements are not shown). The electronic switches or a controller for moving the antenna serves as a switch for switching the effective signal receiving direction of the multi-directional antenna 3. The receiver 33 serves as a control signal receiver and an antenna control signal extractor when it performs a control signal receiving process, and outs the antenna control signal to the control unit 32. The control unit 32 makes an indicated signal receiving direction effective among the signal receiving directions D1 to D16 of the antenna unit 31 corresponding to the inputted antenna control signal. Furthermore, the control unit 32 serves as an antenna setting switch for changing a gain of the amplifier.

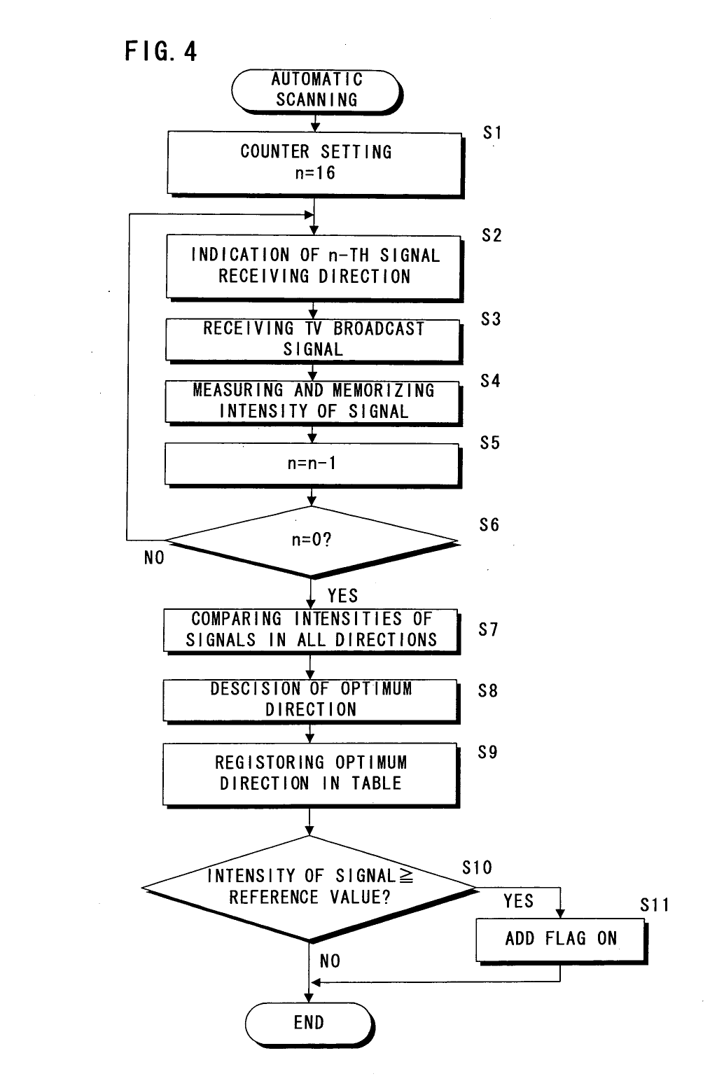

Subsequently, a basic motion of the TV broadcast signal receiver 2A or 2B is described. At first, an automatic scanning process for deciding an optimum signal receiving direction of an optional channel delivered from a TV station is described with reference to a flowchart shown in FIG. 4. When an automatic scanning mode is chosen by a user, and a channel, to which the optimum signal receiving direction is decided, is set, the main controller 25 sets an initial value “n” into a counter corresponding to a number of signal receiving directions of the multi-directional antenna 3 (S1). In this case, since the multi-directional antenna 3 has sixteen signal receiving directions D1 to D16, so that the initial value n=16. Then, the main controller 25 outputs an antenna control signal indicating the n-th signal receiving direction to the multi-directional antenna 3 (S2).

The tuner 21 receives a TV broadcast signal of the channel in the n-th signal receiving direction (S3). Furthermore, the TV broadcast signal receiver 2A or 2B measures an intensity of the received TV broadcast signal(abbreviated as intensity of signal in the flowchart), and memorizes the measured result into the memory 26 (S4). After that, the main controller 25 subtracts a number of the counter by one (S5), and judges whether the intensity of the TV broadcast signal is measured in all signal receiving direction of the multi-directional antenna 3 or not (S6).

When the intensity of the TV broadcast signal is not measured in all signal receiving directions of the multi-directional antenna 3 (NO in S6), the flow returns to the step S2, and the main controller 25 performs the process for measuring the intensity of the TV broadcast signal in the next signal receiving direction of the multi-directional antenna 3.

When the measurement of the intensity of the TV broadcast signal is completed in all signal receiving directions of the multi-directional antenna 3 (YES in S6), the main controller 25 reads out the measured data from the memory 26 and compares all the read-out intensities of the TV broadcast signals in all the signal receiving directions (S7). The main controller 25 decides a direction showing the largest intensity of the TV broadcast signal as the optimum signal receiving direction of the channel (S8), and registers the optimum signal receiving direction of the channel into the table of signal receiving directions (S9).

Furthermore, the main controller 25 judges whether the intensity of the TV broadcast signal in the optimum signal receiving direction is equal to or larger than a predetermined reference value or not (S10). When the intensity of the TV broadcast signal is equal to or larger than the predetermined reference value (YES in S10), the main controller turns the ADD flag on in the table of signal receiving directions (S11), and completes the automatic scanning process. Alternatively, when the intensity of the TV broadcast signal is smaller than the predetermined reference value (NO in S10), the main controller does not turn the ADD flag on ( maintains the OFF state of the ADD flag) in the table of signal receiving directions, and completes the automatic scanning process.

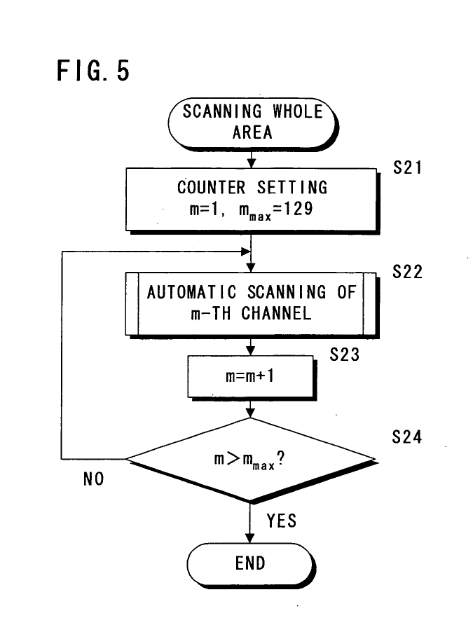

Subsequently, a process for scanning whole area, by which the optimum signal receiving directions of every channels delivered from the TV stations are decided, is described with reference to a flowchart shown in FIG. 5. When the process for scanning whole area is selected by the user, the controller 25 sets an initial value “m” of a counter and a number of channels mₘₐₓ, to which the optimum signal receiving direction are decided corresponding to the number of channels delivered from the TV stations (S21). The main controller 25 performs the above-mentioned automatic scanning process with respect to the m-th channel so as to decide the optimum signal receiving direction and the registered channel information of the channel, and records them into the table of signal receiving directions (S22). Then, the main controller 25 add one to the number of the counter (S23), and judges whether the automatic scanning operation is performed with respect to all the channels or not (S24). When the automatic scanning process is not completed with respect to all channels (NO in S24), the flow returns to the step S22, and the main controller performs the automatic scanning operation with respect to next channel. Alternatively, when the optimum signal receiving direction and the registered channel information are registered into the table of signal receiving directions (YES in S24), the main controller 25 completes the process for scanning whole area.

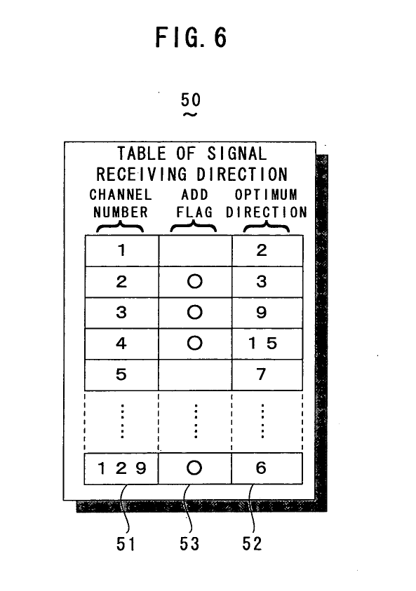

FIG. 6 shows an example of the table of signal receiving directions formed in the above-mentioned process for scanning whole area. In the table of signal receiving directions 50, the optimum signal receiving direction 52 and the registered channel information 53 are memorized with relation to each channel number 51. In addition, an ON state of the ADD flag is shown by a symbol “◯”, and an OFF state of the ADD flag is shown by no mark, in FIG. 6. The numerals shown in the boxes of the optimum signal receiving directions 52 correspond to the signal receiving directions D1 to D16 of the multi-directional antenna 3. For example, the numeral “2” corresponds to the signal receiving direction D2, and the numeral “3” corresponds to the signal receiving direction D3.

The main controller 25 performs channel selection processing for the channels registered as receivable based on the registered channel information. Specifically, the main controller 25 reads out the optimum signal receiving direction of a selected channel from the memory 26, and outputs an antenna control signal for indicating the optimum signal receiving direction of the selected channel to the multi-directional antenna 3.

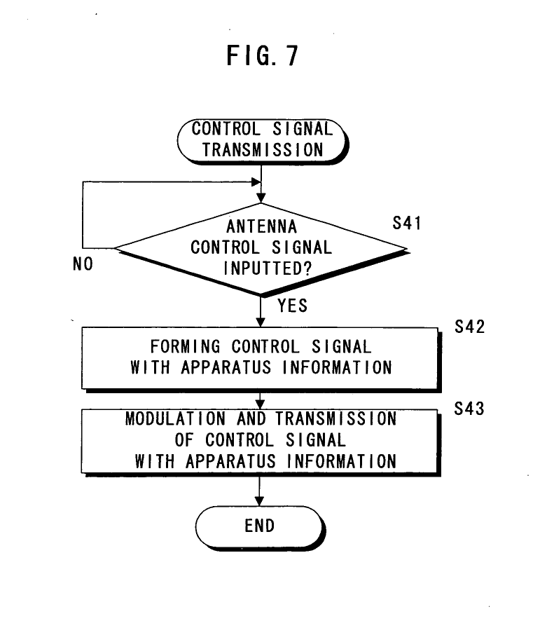

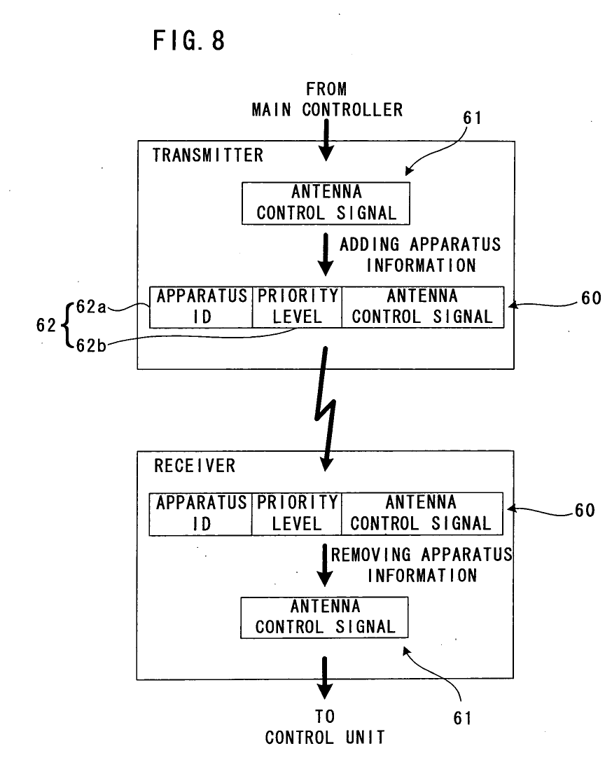

Subsequently, a process for transmitting the control signal by the transmitter 27 is described with reference to FIGS. 7 and 8. The transmitter 27 watches whether an antenna control signal 61 is inputted from the main controller 25 or not (S41). When the antenna control signal 61 is inputted (YES in S41), the transmitter 27 adds apparatus identifying information (abbreviated as apparatus information in the flowchart) 62 to the antenna control signal 6i, so that a control signal 60 with apparatus identifying information is formed (S42). The apparatus identifying information 62 includes an apparatus ID 62a for identifying the TV broadcast signal receivers 2A and 2B, a priority level 62b which is set to each of the TV broadcast signal receivers 2A and 2B. Then, the transmitter 27 modulates the control signal 60 with the apparatus identifying information, and transmits the modulated control signal to the multi-directional antenna 3 via wireless transmission.

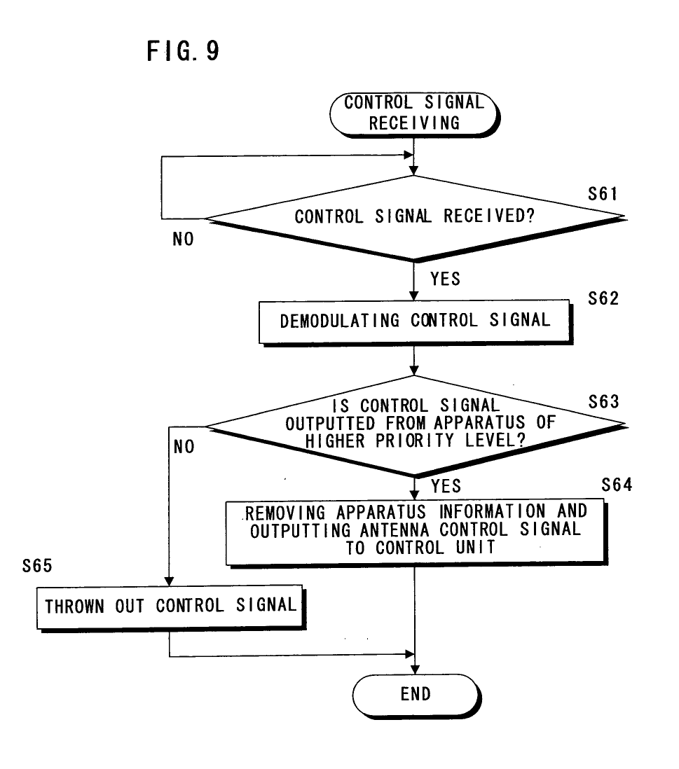

Subsequently, a process for receiving the control signal by the receiver 33 is described with reference to FIGS. 8 and 9. The receiver 33 watches whether the control signal 60 with the apparatus identifying information is transmitted from the transmitter 27 or not (S61). When the receiver 33 receives the control signal 60 (YES in S61), the receiver 33 demodulates the control signal 60 with the apparatus identifying information (S62). Then, the receiver 33 judges whether the control signal 60 is transmitted from the apparatus having a higher priority level or not with reference to the apparatus identifying information 62 included in the control signal 60 (S63). Specifically, the receiver 33 judges whether the priority level of the apparatus newly outputted the control signal 60 is higher than that of the apparatus previously outputted the control signal 60, or not.

When the control signal 60 is outputted from the apparatus having the higher priority level (YES in S63), the receiver 33 removes the apparatus identifying information 62 from the control signal 60 so that the antenna control-signal 61 is extracted in compliance with the CEA-909 technical standard, and outputs the antenna control signal 61 to the control unit 32 (S64). Alternatively, when the control signal 60 is outputted from the apparatus having the lower priority level (NO in S63), the receiver 33 throws out the control signal 60 (S65), and completes the process.

For example, when the TV broadcast signal receiver 2A has a higher priority level than that of the TV broadcast signal receiver 2B, and the receiver 33 has previously received the control signal 60 outputted from the TV broadcast signal receiver 2A, the control signal 60 outputted from the TV broadcast signal receiver 2B will be thrown out. Alternatively, when the receiver 33 has previously received the control signal 60 outputted from the TV broadcast signal receiver 2B, and receives the control signal 60 the control signal 60 outputted from the TV broadcast signal receiver 2A later, the antenna control signal 61 is extracted from the control signal 60 from the TV broadcast signal receiver 2A and inputted to the control unit 32.

In addition, it is possible to provide an expiration term to the antenna control signal 61 so as not to be thrown out the control signal 60 outputted from the apparatus having the lower priority level at all times. After passing the expiration term, the control signal 60 outputted from the apparatus having the lower priority level can be received by the receiver 33. In the above-mentioned example, when the expiration term of the antenna control signal 61 outputted from the TV broadcast signal receiver 2A has passed, the antenna control signal 61 is extracted from the control signal 60 outputted from the TV broadcast signal receiver 2B and inputted to the control unit 32.

According to the TV broadcast signal receiving system 1 of the embodiment, each of the TV broadcast signal receivers 2A and 2B respectively performs the process for transmitting the control signal, so that the control signal 60 with the apparatus identifying information is transmitted to the multi-directional antenna 3 via the wireless transmission. In the multi-directional antenna 3, the process for receiving the control signal is performed for receiving the control signal 60 with the apparatus identifying information and extracting the antenna control signal 61 included in the control signal 60. The effective signal receiving direction of the multi-directional antenna 3 and the gain of the amplifier are switched on the basis of the antenna control signal 61. Thus, the multidirectional antenna 3 can be controlled by the TV broadcast signal receivers 2A and 2B without connecting the TV broadcast signal receivers 2A and 2B to the multidirectional antenna 3 by modular cables. Since it is no need to connect the TV broadcast signal receivers 2A and 2B to the multidirectional antenna 3 by the modular cables, setting up of the TV broadcast signal receivers 2A and 2B and the multidirectional antenna 3 becomes simple and easy.

Furthermore, since the multi-directional antenna 3 extracts the antenna control signal 61 from the control signal 60 only when the control signal 60 is outputted from an apparatus having a higher priority level, and switches the effective signal receiving direction of thereof corresponding to the indication of the antenna control signal 61, it is possible to adjust the capability for controlling the multi-directional antenna 3 between the TV broadcast signal receivers 2A and 2B. Consequently, a single multi-directional antenna can be used commonly among a plurality of TV broadcast signal receivers.

Still furthermore, the multi-directional antenna 3 extracts the antenna control signal 61 from the control signal 60 and switches the effective signal receiving direction only when the control signal 60 is outputted from the apparatus having the higher priority level, so that it is possible to prevent malfunction of switching the effective signal receiving direction by a radio wave such as noise except the control signal from predetermined apparatuses.

In addition, the present invention is not to the above configuration of the embodiment, and various kinds of modification are possible. For example, the apparatus identifying information 62 may include other information further to the apparatus ID 62a and the priority level 62b. Even though the apparatus identifying information 62 includes any information, the apparatus identifying information 62 is added to the control signal by the transmitter 27 and removed from the control signal by the receiver 33. Therefore, the antenna control signal 61 can be transmitted and received in a predetermined form, for example, in compliance with the CEA-909 technical standard between the main controller 25 of the TV broadcast signal receiver 2A or 2B and the control unit 32 of the multi-directional antenna 3, similar to the case that the TV broadcast signal receivers 2A and 2B and the multi-directional antenna 3 are connected by the modular cables.

In contrast, when a single multi-directional antenna is not used commonly by a plurality of the TV broadcast signal receivers, the apparatus identifying information 62 is not necessarily be added to the antenna control signal 61. The antenna control signal 61 may be transmitted to the receiver 33 from the transmitter 27. In addition, the TV broadcast signal which can be received by the TV broadcast signal receivers 2A and 2B may be analog television broadcast signal without it being limited to the digital television broadcast signal.

A television broadcast signal receiving system in accordance with the present invention comprises at least a multi-directional antenna having a plurality of signal receiving directions previously defined and at least one television broadcast signal receiver connected to the multi-directional antenna for receiving a television broadcast signal. The television broadcast signal receiver has a tuner connected to the multi-directional antenna and receiving a television broadcast signal, and a transmitter for transmitting an antenna control signal to the multi-directional antenna via a wireless transmission so as to switch an effective signal receiving direction of the multi-directional antenna while receiving the television broadcast signal. The multi-directional antenna has a receiver for receiving the antenna control signal transmitted from the transmitter of the television broadcast signal receiver, and a switch for switching the effective signal receiving direction among a plurality of signal receiving directions of the multi-directional antenna corresponding to the antenna control signal.

By such a configuration, the antenna control signal is transmitted from the television broadcast signal receiver to the multi-directional antenna via the wireless transmission without using the modular cables, so that the setting up of the television broadcast signal receivers and the multi-directional antenna can be made simple and easy.

It is possible that the transmitter of the television broadcast signal receiver adds apparatus identifying information including an apparatus ID to the antenna control signal for identifying the television broadcast signal receiver from which the antenna control signal is outputted, and the receiver of the multi-directional antenna identifies the television broadcast signal receiver from which the antenna control signal is outputted based on the apparatus identifying information, and extracts the antenna control signal when the television broadcast signal receiver outputted the antenna control signal corresponds to a predetermined apparatus to be responded.

By such a configuration, the apparatus which outputs the antenna control signal is identified with reference to the apparatus identifying information. If the apparatus does not correspond to the predetermined apparatus to be responded, the antenna control signal will be ignored. Thus, even when the antenna control signal is outputted from an apparatus which has no capability for controlling the multi-directional antenna, or a quasi antenna control signal similar to the antenna control signal is inputted to the multi-directional antenna due to noise signal, it is possible to prevent malfunction of switching the effective signal receiving direction of the multi-directional antenna.

Furthermore, it is possible that the apparatus identifying information further includes a priority level, and the receiver of the multi-directional antenna compares the priority level of the television broadcast signal receiver from which the antenna control signal is newly outputted with a priority level of a television broadcast signal receiver from which an antenna control signal is previously outputted, extracts the antenna control signal when the priority level of the television broadcast signal receiver from which the antenna control signal is newly outputted is higher than that of the television broadcast signal receiver from which the antenna control signal is previously outputted, and outputs the extracted antenna control signal to the switch so as to switch the effective signal receiving direction of the multi-directional antenna corresponding to indication of the antenna control signal.

By such a configuration, when a plurality of antenna control signals is outputted from different television broadcast signal receivers, the multi-directional antenna compares the priority levels of these television broadcast signal receivers, and makes the antenna control signal effective which is outputted from the television broadcast signal receiver having the highest priority level. Thus, it is possible to prevent that the effective signal receiving direction of the multi-directional antenna is frequently switched.

Still furthermore, it is possible that the antenna control signal is thrown out when the priority level of the television broadcast signal receiver from which the antenna control signal is newly outputted is smaller than that of the television broadcast signal receiver from which the antenna control signal is previously outputted.

By such a configuration, the antenna control signal which is outputted from the apparatus irresponsive can easily be ignored, so that the malfunction of switching of the effective signal receiving direction of the multi-directional antenna can be prevented.

Still furthermore, it is possible that the antenna control signal further includes an expiration term; and when the expiration term of the antenna control signal previously outputted has passed, the receiver of the multi-directional antenna extracts the antenna control signal with no relation to the priority level of the television broadcast signal receiver, and outputs the extracted antenna control signal to the switch so as to switch the effective signal receiving direction of the multi-directional antenna corresponding to indication of the antenna control signal.

By such a configuration, when the effective signal receiving direction of the multi-directional antenna is not switched while a predetermined term, it is possible to give a capability to the television broadcast signal receivers having lower priority level. Thus, the television broadcast signal receiving system can be used by a plurality of users evenly.

This application is based on Japanese patent application 2004-201708 filed Jul. 8, 2004 in Japan, the contents of which are hereby incorporated by references.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

What is claimed is:

1. A television broadcast signal receiving system comprising a multi-directional antenna having a plurality of signal receiving directions previously defined and at least one television broadcast signal receiver connected to the multi-directional antenna for receiving a television broadcast signal, wherein
the television broadcast signal receiver has a tuner connected to the multi-directional antenna and receiving a television broadcast signal, and a transmitter for transmitting an antenna control signal to the multi-directional antenna via a wireless transmission so as to switch an effective signal receiving direction of the multi-directional antenna while receiving the television broadcast signal; and
the multi-directional antenna has a receiver for receiving the antenna control signal transmitted from the transmitter of the television broadcast signal receiver, and a switch for switching the effective signal receiving direction among a plurality of signal receiving directions of the multi-directional antenna corresponding to the antenna control signal.

2. The television broadcast signal receiving system in accordance with claim 1, wherein
the transmitter of the television broadcast signal receiver adds apparatus identifying information including an apparatus ID to the antenna control signal for identifying the television broadcast signal receiver from which the antenna control signal is outputted; and
the receiver of the multi-directional antenna identifies the television broadcast signal receiver from which the antenna control signal is outputted based on the apparatus identifying information, and extracts the antenna control signal when the television broadcast signal receiver outputted the antenna control signal corresponds to a predetermined apparatus to be responded.

3. The television broadcast signal receiving system in accordance with claim 2, wherein
the apparatus identifying information further includes a priority level; and
the receiver of the multi-directional antenna compares the priority level of the television broadcast signal receiver from which the antenna control signal is newly outputted with a priority level of a television broadcast signal receiver from which an antenna control signal is previously outputted, extracts the antenna control signal when the priority level of the television broadcast signal receiver from which the antenna control signal is newly outputted is higher than that of the television broadcast signal receiver from which the antenna control signal is previously outputted, and outputs the extracted antenna control signal to the switch so as to switch the effective signal receiving direction of the multi-directional antenna corresponding to indication of the antenna control signal.

4. The television broadcast signal receiving system in accordance with claim 3, wherein
the antenna control signal is thrown out when the priority level of the television broadcast signal receiver from which the antenna control signal is newly outputted is smaller than that of the television broadcast signal receiver from which the antenna control signal is previously outputted.

5. The television broadcast signal receiving system in accordance with claim 2, wherein
the antenna control signal further includes an expiration term; and
when the expiration term of the antenna control signal previously outputted has passed, the receiver of the multi-directional antenna extracts the antenna control signal with no relation to the priority level of the television broadcast signal receiver, and outputs the extracted antenna control signal to the switch so as to switch the effective signal receiving direction of the multi-directional antenna corresponding to indication of the antenna control signal.

6. A television broadcast signal receiving system comprising a multi-directional antenna having a plurality of signal receiving directions previously defined and at least one television broadcast signal receiver connected to the multi-directional antenna for receiving a television broadcast signal, wherein
the television broadcast signal receiver comprises:
a television broadcast signal receiving means for receiving a television broadcast signal through the multi-directional antenna;
a control signal generating means for generating a control signal with apparatus identifying information by adding apparatus identifying information including an apparatus ID for identifying a television broadcast signal receiver connected to the multi-directional antenna and priority level correspondingly set to the apparatus ID to an antenna control signal for controlling an effective signal receiving direction of the multi-directional antenna and gain of an amplifier; and
a control signal transmitting means for transmitting the control signal with apparatus identifying information to the multi-directional antenna; and
the multi-directional antenna comprises:
a control signal receiving means for receiving the control signal with apparatus identifying information transmitted from the television broadcast signal receiver;
an antenna control signal extracting means for extracting the antenna control signal in compliance with CEA-909 from the control signal with apparatus identifying information by removing the apparatus identifying information, when the priority level of the control signal with apparatus identifying information newly received is not lower than that of a control signal with apparatus identifying information previously received; and
an antenna setting switching means for switching the effective signal receiving direction and the gain of the amplifier of the multi-directional antenna corresponding to the extracted antenna control signal.
